(19) United States
(12) Patent Application Publication
(10) Pub. No.: US 2021/0262874 A1
(43) Pub. Date: Aug. 26, 2021

(54) LOAD TRANSDUCER WITH SERIAL SYNCHRONOUS INTERFACE

(71) Applicant: Enerpac Tool Group Corp., Menomonee Falls, WI (US)

(72) Inventor: Nick Joseph Tolley, Wauwatosa, WI (US)

(21) Appl. No.: 16/800,542

(22) Filed: Feb. 25, 2020

(51) Int. Cl. G01L 1/22; H02M 7/88

(52) U.S. Cl. CPC G01L 1/2293; H02M 2001/0067; H02M 7/88

(57) ABSTRACT

A load-sensor-based system utilizing a digital serial synchronous interface (SSI). One example system includes an A/D converter configured to be coupled to a load sensor and to receive signals indicating a load on the load sensor. A first controller is coupled to the A/D converter and to the SSI and is configured to receive, via the A/D converter, a first signal at a first sampling rate. The first controller is also configured to receive, via the A/D converter, a second signal at the first sampling rate, and receive, via the SSI, a request for a load value at a first period of time. The first controller is configured to determine the load value at the first period of time based on the first and second signals, and send, via the SSI, the load value at the first period of time to the load controller.

### FIELD

Embodiments described herein relate to a load transducer utilizing a digital serial synchronous interface.

### SUMMARY

A load sensor is often a measuring element within a type of transducer that converts various mechanical loads, such as force, torque, pressure, and the like, into a measurable electrical signal. A device can then measure the electrical signal. For example, by sending an excitation signal across a Wheatstone bridge containing a strain gauge or strain gauges, the device may receive an electrical signal indicative of the load applied to the transducer. This signal may further be utilized by the device itself or be provided to a system to perform some action, such as adjusting an actuator, a piston, or the like. In this manner, strain-gauge-based transducers may be used by control systems.

In a mechanical system utilizing closed-loop control, successive measurements are used by a controller to update its estimate of the state of the system. Typically, the controller will input each successive measurement into its calculations that estimate the state of the system and optimize the command signal the controller sends back to the system. Many of these calculations rely on derivatives taken with respect to time. Fluctuations in the timing of these measurements will manifest as errors in time-based derivatives. Because of this, how precisely measurements are aligned within the time domain affect the performance/behavior of a system that utilizes closed-loop control. Therefore, it can be important that the information being provided to controller by a sensor/transducer is precisely aligned in the time domain.

To address these and other concerns, systems and methods described herein provide, among other things, devices and methods for converting a measurement or load signal from a load transducer to a digital signal utilized by a serial synchronous interface. Some embodiments provide active time-domain synchronization to minimize time distortion experienced by the system. Some embodiments may be embedded within the body of a larger transducer or housed within a chassis, removing the need for long wires.

One embodiment provides a system that includes an analog-to-digital (A/D) converter configured to be coupled to a load sensor and configured to receive signals indicating a load on the load sensor. The system also includes a serial synchronous interface (SSI), a first controller coupled to the A/D converter and coupled to the SSI, and a load controller coupled to the SSI. The first controller is configured to receive, via the A/D converter, a first signal at a first sampling rate, receive, via the A/D converter, a second signal at the first sampling rate, and receive, via the SSI, a request for a load value at a first period of time. The first controller is also configured to determine the load value at the first period of time based on the first signal and the second signal, and send, via the SSI, the load value at the first period of time to the load controller.

In some embodiments, the first controller is configured to determine, based on the first signal and the second signal, a rate of change of the load on the load sensor. In some embodiments, the first controller is also configured to determine, based on the rate of change of the load on the load sensor, the load value at the first period of time. In some embodiments, the first controller is configured to receive, via the SSI, a clock signal at a second sampling rate different from the first sampling rate. In some embodiments, the request for a load value is a pause in the clock signal.

In some embodiments, the first controller is configured to receive, via the SSI, a second clock signal at a third sampling rate different than the second sampling rate, and adjust the sampling rate of the A/D converter to a fourth sampling rate at least twice the sampling rate of the third sampling rate. In some embodiments, the first controller is configured to apply a first time-stamp to the first signal upon receiving the first signal, and apply a second time-stamp to the second signal upon receiving the second signal. In some embodiments, the first controller is also configured to apply a calibration equation to the first signal upon receiving the first signal, and apply the calibration equation to the second signal upon receiving the second signal.

In some embodiments, the A/D converter, the SSI interface, and the first controller are situated within at least one selected from a group consisting of a load cell, a torque transducer, and a pressure sensor. In some embodiments, the A/D converter is coupled directly to a load cell. In some embodiments, the system also includes an actuator coupled to the load controller. The load controller is configured to control the actuator based on the load value at the first time period.

Another embodiment provides a method for determining a load value of a load sensor. In one example, the method includes receiving, at an A/D converter, a first signal, quantizing, at the A/D converter, the first signal, and receiving, at an electronic processor, the quantized first signal. The method also includes receiving, at the A/D converter, a second signal, quantizing, at the A/D converter, the second signal, and receiving, at the electronic processor, the quantized second signal. The method also includes receiving, at the electronic processor, a request for the load value, determining, at the electronic processor and based on the quantized first signal and the quantized second signal, the load value, and transmitting, via a SSI, the load value to a load controller.

In some embodiments, the method also comprises determining, based on the quantized first signal and the quantized second signal, a rate of change of a load experienced by the load sensor. In some embodiments, the method also includes applying a first time-stamp to the quantized first signal upon receiving the quantized first signal, and applying a second time-stamp to the quantized second signal upon receiving the second signal. In some embodiments, the method also includes applying a calibration equation to the quantized first signal upon receiving the quantized first signal, and applying the calibration equation to the quantized second signal upon receiving the second signal.

In some embodiments, the method also includes receiving, at the load controller, the load value, comparing the load value to a predetermined value, and determining an error based on the comparison. In some embodiments, the method includes adjusting an actuator coupled to the load controller based on the error.

Other aspects of various embodiments will become apparent by consideration of the detailed description and accompanying drawings.

### BRIEF DESCRIPTION OF THE DRAWINGS

FIG. 1 illustrates a system to analyze and transmit a load value according to one embodiment.

FIG. 2 illustrates a controller for the system of FIG. 1 according to one embodiment.

FIG. 3 illustrates an example of a method performed by the controller of FIG. 2.

FIGS. 4A and 4B illustrate examples of signals received by the controller of FIG. 2.

FIG. 5 illustrates an example of a method performed by a load controller of FIG. 1.

FIG. 6A illustrates an example adjustment performed by the load controller of FIG. 1.

FIG. 6B illustrates an example adjustment performed by the load controller of FIG. 1.

### DETAILED DESCRIPTION

Before any embodiments are explained in detail, it is to be understood that the embodiments are not limited in their application to the details of the configuration and arrangement of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more electronic processors, for example, one or more microprocessors and/or application specific integrated circuits (“ASICs”). As a consequence, it should be noted that a plurality of hardware and software based devices, as well as a plurality of different structural components, may be utilized to implement the embodiments. For example, “servers” and “computing devices” described in the specification can include one or more processing units, one or more computer-readable medium modules, one or more input/output interfaces, and various connections (e.g., a system bus) connecting the components.

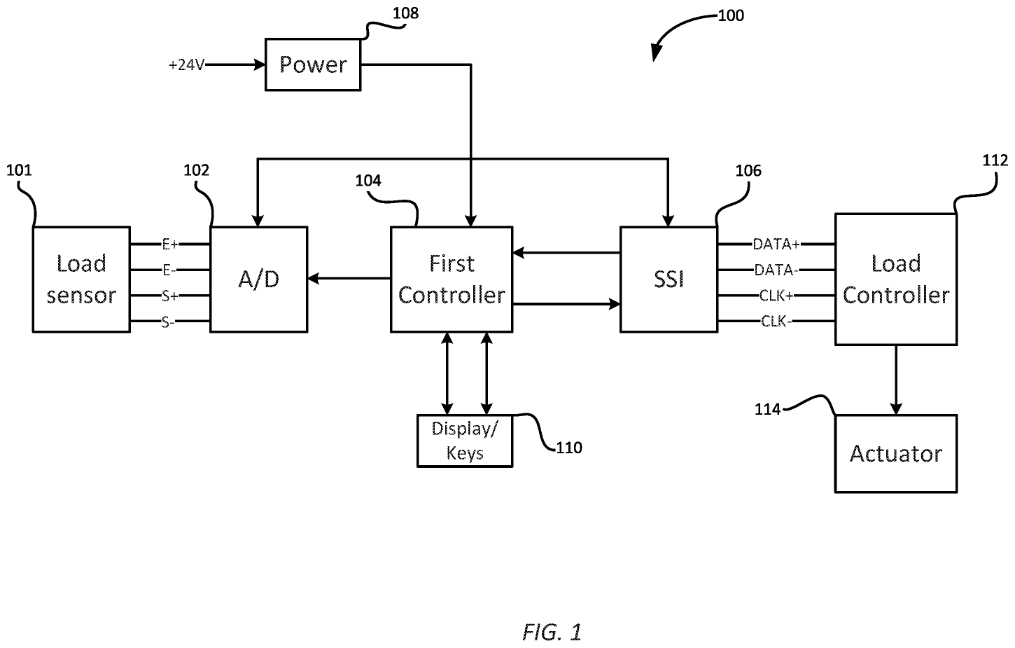

FIG. 1 illustrates a system 100 configured to analyze and transmit a load value, according to some embodiments. System 100 includes a load sensor 101, an analog-to-digital (A/D) converter 102, a first controller 104, a serial synchronous interface (SSI) 106, and an external or load controller 112. In some embodiments, the system 100 may further include a power source 108, input and output devices illustrated generically as a display/keys device 110, and an actuator 114. In the example shown, the load sensor 101 is connected to an analog-to-digital (A/D) converter 102 via the lines (e.g., wires) E+, E−, S+ and S−. In some embodiments, the load sensor 101 is a strain gauge, a strain sensor, a pressure sensor, or the like. In some embodiments, the A/D converter 102 sends an excitation signal to the load sensor 101 via the E+ and E− lines. For example, the A/D converter 102 may supply an excitation signal of 3.3 V to the load sensor 101. In some embodiments, the A/D converter 102 then receives a signal (e.g., sensor signal, load signal, strain signal) from the load sensor 101 via the S+ and S− lines, the signal indicating a load experienced by the load sensor 101. For example, in response to receiving the excitation signal of 3.3 V, the load sensor 101 may supply a signal with a load value of approximately 6.6 mV. Since the output of the load sensor 101 depends on the excitation signal, the resulting units may be, for example, mV/V.

Upon receiving the signal from the load sensor 101, the A/D converter 102 converts the signal into a quantized signal (e.g., digital signal). Quantizing the signal may be performed at a frequency defined by the sampling rate of the A/D converter 102 (e.g., a first sampling rate). The sampling rate may be, for example, 500 Hz, 1.2 kHz, 2.4 kHz, 4.8 kHz, or the like. Additionally, the quantized signal may be a 8-bit sample, 16-bit sample, 24-bit sample, or a 32-bit sample.

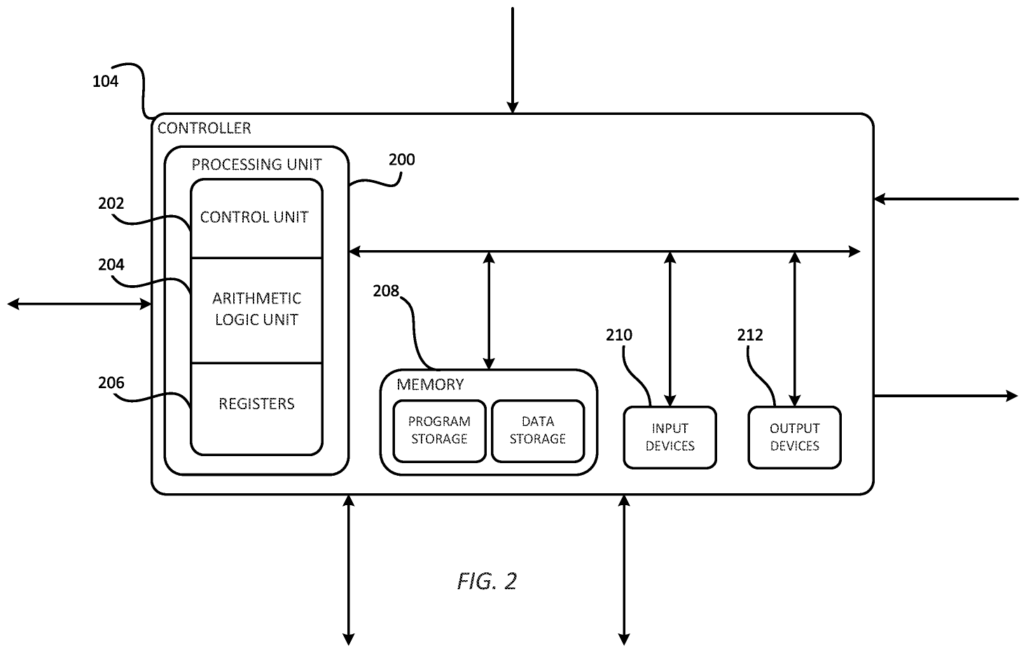

The A/D converter 102 is configured to be coupled to the first controller 104, shown in FIG. 2. The first controller 104 includes a plurality of electrical and electronic components that provide power, operational control, and protection to the components and modules within the first controller 104 and/or the system 100. For example, the first controller 104 includes, among other things, an electronic processor 200 (e.g., a microprocessor, a microcontroller, or another suitable programmable device), a memory 208, input devices 210, and output devices 212. The electronic processor 200 includes a control unit 202, an arithmetic logic unit (“ALU”) 204, a plurality of registers 206 (shown as a group of registers in FIG. 2). The electronic processor 200, the memory 208, the input devices 210, and the output devices 212, as well as various modules or circuits connected to the first controller 104 are connected by one or more control and/or data buses.

The memory 208 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The electronic processor 200 is connected to the memory 208 and executes software instructions that are capable of being stored in a RAM of the memory 208 (e.g., during execution), a ROM of the memory 208 (e.g., on a generally permanent basis), or another non-transitory computer readable medium such as another memory or a disc. Software included in the implementation of the system 100 and first controller 104 can be stored in the memory 208 of the first controller 104. The software includes, for example, firmware, one or more applications, program data, filters, rules, one or more program modules, and other executable instructions. The first controller 104 is configured to retrieve from the memory 208 and execute, among other things, instructions related to the control processes and methods described herein. In other embodiments, the first controller 104 includes additional, fewer, or different components. For example, the first controller 104 may be coupled to the power source 108 configured to provide power to the system 100. In some embodiments, the power source 108 may provide 24V to the system 100. In some embodiments, the first controller 104 may be coupled to the display/keys device 110. The display/keys device 110 may include the input devices 210 and output devices 212. The input devices 210 provide a mechanism through which a user inputs commands to the first controller 104.

Returning to FIG. 1, the first controller 104 may receive the quantized signal from the A/D converter 102. The signal may be sent from the A/D converter 102 to the first controller 104 based on the sampling frequency of the A/D converter 102. For example, the signal may be sent immediately following the quantization of the signal. This sampling frequency may be asynchronous with a clock of the first controller 104. In some embodiments, the signal is sent based on a SHIFT of registers within the A/D converter 102. For example, once the A/D converter 102 receives a second signal, the first signal is sent to the first controller 104, allowing the A/D converter 102 to store the second signal. Upon receiving the signal, the first controller 104 stores the signal in the memory 208. In some embodiments, the first controller 104 places a time-stamp on the signal to indicate the time at which the signal was received.

In some embodiments, the first controller 104 calibrates the signal by applying a calibration equation. For example, the calibration equation may be configured to adjust or apply a unit of measurement used by the first controller 104. The calibration equation may change the units from mv/V to a unit related to force, such as

$$\frac{N}{{m}^{2}} ,$$

Pa, lbf (pound-force), or the like.

In the example shown, the first controller 104 is coupled to the serial synchronous interface (SSI) 106. The SSI 106 may be further coupled to a load controller 112 (e.g., an external controller). The load controller 112 may have a similar architecture as the first controller 104. The SSI 106 maintains time synchronization between the first controller 104 and the load controller 112. For example, if the load controller 112 operates with a clock frequency of 4 kHz, the SSI 106 ensures the first controller 104 also operates at an identical clock signal. As a consequence, the first controller 104 may receive, via the SSI 106, a clock signal at a second sampling rate from the load controller 112 that is different from the first sampling rate provided by the A/D converter 102. The load controller 112 is configured to be coupled to an actuator 114 and control operation of the actuator 114. In some embodiments, the actuator 114 provides the force measured by the load sensor 101. Accordingly, the load controller 112 may request information regarding the load sensor 101 from the first controller 104.

A wire connecting the load cell to the A/D converter 102 may be impacted by electromagnetic fields, creating noise in signals transmitted between the load cell and the A/D converter 102. To reduce this noise, all, or portions of, system 100 may be located within a load cell. For example, the load sensor 101, A/D converter 102, first controller 104, and SSI 106 may be located within the load cell. Placing these components within the load cell reduces the length of wire that may be used in creating electrical connection between the components of system 100. Additionally, by reducing the wire and the noise, time derivatives used in control calculations may be more accurate. In some embodiments, noise reduction is the result of a housing of the load cell. In some embodiments, the load sensor 101 is coupled directly to the load cell. In some embodiments, the load sensor 101, A/D converter 102, first controller 104, and SSI 106 may be situated within one selected from a group consisting of a load cell, a pressure sensor, and a torque transducer.

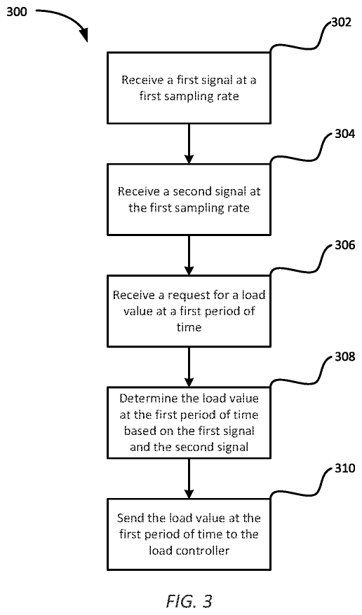

FIG. 3 illustrates one example of a method 300 executed by a computing device, such as the first controller 104, according to some embodiments. At block 302, the first controller 104 receives, via the A/D converter 102, a first signal at a first sampling rate. The first signal may be a quantized signal. The first sampling rate may be the sampling rate of the A/D converter 102. The first controller 104 may apply a time-stamp to the first signal. For example, the first signal receives a time stamp indicating it was received at 0.42 ms. The first controller 104 may also calibrate the first signal, for example, by applying a calibration equation to the first signal. At block 304, the first controller 104 receives, via the A/D converter 102, a second signal at the first sampling rate. The second signal may also be a quantized signal. The first controller 104 may apply a time-stamp to the second signal. For example, the second signal may receive a time stamp indicating it was received at 0.84 ms. The first controller 104 may further apply a calibration equation to the second signal.

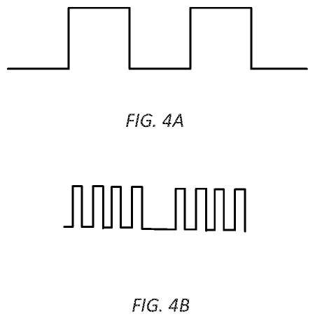

At block 306, the first controller 104 receives, via the SSI 106, a request for a load value at a first period of time. For example, the first controller 104 receives a data request from the load controller 112 at the time value 1.0 ms. In some embodiments, the data request may be, for example, a pause in the clock signal provided by the load controller 112 to the first controller 104 through the SSI 106. For example, FIGS. 4A-4B illustrate example clock signals received by the first controller 104. FIG. 4A shows a standard clock signal having a plurality of evenly-spaced edges. FIG. 4B, however, shows a clock signal having a plurality of edges with a missing edge. The request may be, for example, an extended “low” clock signal, wherein the clock signal has a “low” value for a predetermined period of time, or an extended “high” clock signal, wherein the clock signal has a “high” value for a predetermined period of time. When the first controller 104 receives a clock signal similar to that of the clock signal of FIG. 4B, the first controller 104 determines the load controller 112 has transmitted a data request.

At block 308, the first controller 104 determines the load value at the first period of time based on the first signal and the second signal. For example, if the first signal was received at 0.42 ms, and the second signal was received at 0.84 ms, but the request is received at 1.0 ms, the first controller 104 extrapolates the load value at the time the request was received. To extrapolate the load value, the first controller 104 may determine, based on the first signal and the second signal, a rate of change of the load on the load sensor 101. The first controller 104 may then determine, based on the rate of change of the load on the load sensor 101, the load value at the first period of time. At block 310, the first controller 104 sends, via the SSI 106, the load value at the first period of time to the load controller 112.

In the example, just described two signals were explained. In some embodiments, the first controller 104 receives a third signal at the first sampling rate prior to receiving the request for a load value. For example, the first controller 104 may receive the first signal at 0.31 ms, the second signal at 0.62 ms, and the third signal at 0.93 ms. When receiving the request for a load value from the load controller 112, the first controller 104 extrapolates the load value using the first signal, the second signal, and the third signal by determining a rate of change of the load on the load sensor 101, similar to that as defined above. In some embodiments more than two signals may be received and processed. Thus, the method 300 may be adjusted for a varying number of signals received by the first controller 104 and is not limited to the examples explicitly provided.

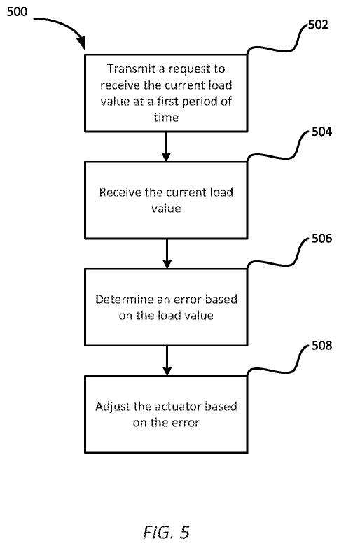

FIG. 5 illustrates a method 500 performed by the load controller 112, according to some embodiments. At block 502, the load controller 112 transmits, via the SSI 106, a request to receive the current load value at a first period of time. At block 504, the load controller 112 receives, via the SSI 106, the current load value.

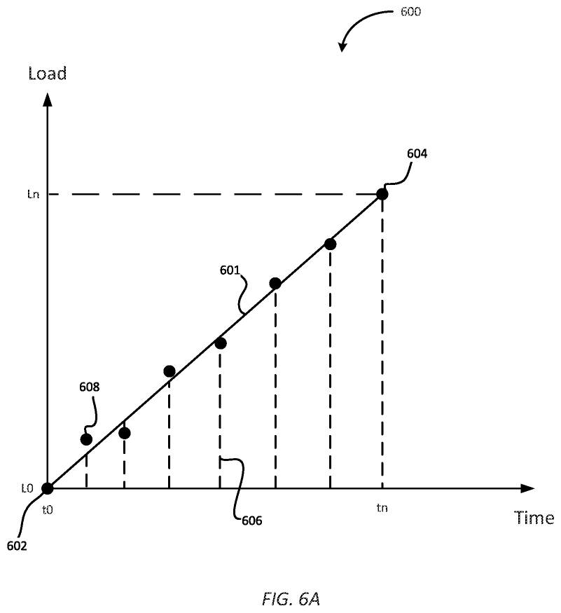

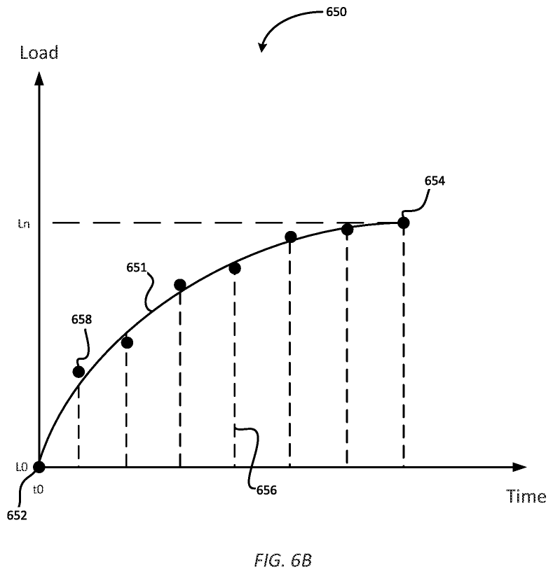

At block 506, the load controller 112 determines an error based on the load value. For example, FIG. 6A illustrates an example of a first predetermined function 601 performed by the load controller 112. In the example 600, the first predetermined function 601 is a linear function. The first predetermined function 601 has a starting value 602 having a load of L0 at time t0. The first predetermined function 601 has an ending value 604 having a load of Ln at time tn. As the load controller 112 performs the first predetermined function 601, it may transmit a request for a load value to the first controller 104, the request indicated by the request lines 606. The load controller 112 receives the load value at the time of the request line 606, the load value indicated by load values 608. The load controller 112 may subtract the load value 608 from the first predetermined function 601 at the current time period to determine the error.

FIG. 6B illustrates an example of a second predetermined function 651 performed by the load controller 112. In the example 650, the second predetermined function 651 is a non-linear function. Similar to first predetermined function 601, the second predetermined function 651 includes a starting value 652, an ending value 654, request lines 656, and load values 658. The load controller 112 may subtract the load value 658 from the second predetermined function 651 at the current time period to determine the error.

Returning to FIG. 5, at block 508, the load controller 112 is configured to adjust the actuator 114 based on the error. For example, the load controller 112 may determine that a piston is applying too much force too quickly. The load controller 112 will adjust the piston to better fit the desired predetermined function. In some embodiments, the error may be determined by comparing the load value to a predetermined load threshold. The load controller 112 may then adjust the actuator 114 based on the load threshold.

In some embodiments, the frequency at which the load controller 112 requests load values may change. For example, the frequency at which the load controller 112 requests load values may double. When this occurs, the frequency at which the first controller 104 receives signals must increase to maintain a frequency at least twice that of the request frequency (e.g., the Nyquist rate). In the case that the frequency at which the first controller 104 receives signals is less than twice the frequency the first controller 104 receives requests from the load controller 112, the first controller 104 is unable to determine a load value. Accordingly, in some embodiments, the first controller 104 adjusts the frequency of the A/D converter 102 based on the request frequency of the load controller 112. If the frequency at which the load controller 112 requests load values doubles, the first controller 104 will at least double the frequency of the A/D converter 102 such that there are always at least two signals to use for extrapolation.

Thus, embodiments provide, among other things, systems, methods, and devices for receiving and transmitting load values from a load sensor. Various features and embodiments are set forth in the following claims.

What is claimed is:

1. A system comprising:
an analog-to-digital converter configured to be coupled to a load sensor and configured to receive signals indicating a load on the load sensor;
a serial synchronous interface;
a first controller coupled to the analog-to-digital converter and coupled to the serial synchronous interface; and
a load controller coupled to the serial synchronous interface, wherein the first controller is configured to:
receive, via the analog-to-digital converter, a first signal at a first sampling rate;
receive, via the analog-to-digital converter, a second signal at the first sampling rate;
receive, via the serial synchronous interface, a request for a load value at a first period of time;
determine the load value at the first period of time based on the first signal and the second signal; and
send, via the serial synchronous interface, the load value at the first period of time to the load controller.

2. The system of claim 1, wherein the first controller is further configured to:
determine, based on the first signal and the second signal, a rate of change of the load on the load sensor.

3. The system of claim 2, wherein the first controller is further configured to:
determine, based on the rate of change of the load on the load sensor, the load value at the first period of time.

4. The system of claim 1, wherein the first controller is further configured to:
receive, via the serial synchronous interface, a clock signal at a second sampling rate different from the first sampling rate.

5. The system of claim 4, wherein the request for the load value is a pause in the clock signal.

6. The system of claim 4, wherein the first controller is further configured to:
receive, via the serial synchronous interface, a second clock signal at a third sampling rate different than the second sampling rate; and
adjust the sampling rate of the analog-to-digital converter to a fourth sampling rate at least twice the sampling rate of the third sampling rate.

7. The system of claim 1, wherein the first controller is further configured to:
apply a first time-stamp to the first signal upon receiving the first signal; and
apply a second time-stamp to the second signal upon receiving the second signal.

8. The system of claim 1, wherein the first controller is further configured to:
apply a calibration equation to the first signal upon receiving the first signal; and
apply the calibration equation to the second signal upon receiving the second signal.

9. The system of claim 1, wherein the analog-to-digital converter, the serial synchronous interface, and the first controller are situated within at least one selected from a group consisting of a load cell, a torque transducer, and a pressure sensor.

10. The system of claim 1, wherein the analog-to-digital converter is coupled directly to a load cell.

11. The system of claim 1, further comprising:
an actuator coupled to the load controller, the load controller configured to control the actuator based on the load value at the first period of time.

12. A method executed on a computing device for determining a load value of a load sensor, the method comprising:
receiving, at an analog-to-digital converter, a first signal;
quantizing, at the analog-to-digital converter, the first signal;
receiving, at an electronic processor, the quantized first signal;
receiving, at the analog-to-digital converter, a second signal;
quantizing, at the analog-to-digital converter, the second signal;
receiving, at the electronic processor, the quantized second signal;
receiving, at the electronic processor, a request for the load value;
determining, at the electronic processor and based on the quantized first signal and the quantized second signal, the load value; and
transmitting, via a serial synchronous interface, the load value to a load controller.

13. The method of claim 12, further comprising:
determining, based on the quantized first signal and the quantized second signal, a rate of change of a load experienced by the load sensor.

14. The method of claim 12, further comprising:
applying a first time-stamp to the quantized first signal upon receiving the quantized first signal; and
applying a second time-stamp to the quantized second signal upon receiving the second signal.

15. The method of claim 12, further comprising:
applying a calibration equation to the quantized first signal upon receiving the quantized first signal; and
applying the calibration equation to the quantized second signal upon receiving the second signal.

16. The method of claim 12, further comprising:
receiving, at the load controller, the load value;
comparing the load value to a predetermined value; and
determining an error based on the comparison.

17. The method of claim 16, further comprising adjusting an actuator coupled to the load controller based on the error.
